(19) United States
(12) Patent Application Publication
(10) Pub. No.: US 2003/0086682 A1
(43) Pub. Date: May 8, 2003

(54) System and method for creating synchronized multimedia presentations

(76) Inventors: Aaron Schofield, Cedar Hills, UT (US); Stephen Aaron Brammer, Lehi, UT (US); John Moody, Orem, UT (US)

Correspondence Address: MICHAEL W. STARKWEATHER, JONES, WALDO, HOLBROOK & MCDONOUGH, 170 South Main Street, Suite 1500, Salt Lake City, UT, 84101-1644, US

(21) Appl. No.: 09/960,198

(22) Filed: Sep. 21, 2001

(51) Int. Cl. H04N 5/76; G11B 27/00

(52) U.S. Cl. 386/46; 386/52

(57) ABSTRACT

Disclosed herein is a method for creating a synchronized multimedia presentation. The first step of the process is to provide an encoded video portion of a presentation. This video portion can be prerecorded or recorded in real time. Next, at least one image is extracted from a media portion of the presentation. The extracted image is synchronized to the video portion of the presentation, and the video portion and synchronized extracted images are then outputted to a predetermined source, such as a hard drive or an Internet server.

### THE FIELD OF THE INVENTION

The present invention relates to a system and method for creating and recording synchronized multimedia presentations, and more particularly to a process that allows a non-programmer to create and record a high-quality synchronized multimedia presentation that can be available for immediate distribution.

### BACKGROUND OF THE INVENTION

Multimedia presentations are becoming a widely used format for conducting lectures, seminars, etc. Typically, in a multimedia presentation, a lecturer will speak, and at designated times in the lecture, will display a slide or video clip, or other similar media presentation (for example, PowerPoint®, available through Microsoft, Inc. of Redmond, Wash.). In order to record such a presentation for distribution, for example via CDROM or over the Internet, it would be necessary to record the lecturer, then synchronize the media presentations to the recorded lecture.

The final product generated by such a process is crude and not well-suited for distribution to potential viewers. Moreover, under current techniques, production is a cumbersome process. For example, assume an individual had a lecture and slide presentation (such as PowerPoint®) that he wished to distribute via CDROM. First, the lecture would need to be recorded, and it would be necessary to identify at what points within the lecture the slides occur. For example, if slide number one was displayed five minutes into the lecture, this would need to be noted. Then, if slide number two was displayed seven minutes into the lecture, this too would be noted.

Once the timing of the slides was identified, appropriate files would then need to be written (e.g. HTML files) indicating the times of the slide changes. Additional files would also need to be written directing the play of both the slides and the video at the same time. The video would then be encoded, ensuring that the slides are synchronized therewith.

Thus, there is generally a significant delay between the time the presentation is recorded, and a suitable copy of the presentation is available for distribution. Such a delay is disadvantageous if it is desired to present a copy of the presentation to participants immediately near the end of the presentation. Moreover, under such an approach, the individuals who wish to distribute their presentations would need literacy in suitable programming languages. In other words, under the current system, a presenter would need to be skilled in a language such as HTML in order to write all the necessary files (i.e. files that tell what time to display the slides, or files that direct the playing of the encoded video and slides at the same time). Additionally, the presenter would need to specify the final layout of the presentation. This also requires knowledge of HTML. Furthermore, if a table of contents of the slides is desired on the final product, the presenter would need knowledge of JAVA.

It would therefore be desirable to have a process for creating a multimedia presentation that enables one without specific programming skills to be able to create the synchronized presentation, while also providing high quality output that is available for immediate distribution.

The following U.S. patents relate to multimedia presentations. Each of these references is incorporated by reference for its supporting teachings.

U.S. Pat. No. 5,832,171 to Heist discloses a method and apparatus for creating a video product with synchronized video and text of an event. The video product allows a user to play back a video of the event, while simultaneously viewing the corresponding transcript. If an original transcript was made of the event, the video product allows the user to play back the video while also viewing the page and line numbers of the original transcript.

U.S. Pat. No. 6,212,547 B1 to Ludwig et al. discloses a multimedia collaboration system that integrates separate real-time and asynchronous networks—the former real-tine audio and video, and the latter for control signals and textual, graphical and other data—in a manner that is interoperable across different computer and network operating system platforms and which closely approximates the experience of face-to-face collaboration, while liberating the participants from the limitations of time and distance. These capabilities are achieved by exploiting a variety of hardware, software and networking technologies in a manner that preserves the quality and integrity of audio/video/data and other multimedia information, even after wide area transmission, and at a significantly reduced networking cost as compared to what would be required by presently known approaches. The system architecture is readily scalable to the largest enterprise network environments. It accommodates differing levels of collaborative capabilities available to individual users and permits high-quality audio and video capabilities to be readily superimposed onto existing personal computers and workstations and their interconnecting LANs and WANs. In a particular preferred embodiment, a plurality of geographically dispersed multimedia LANs are interconnected by a WAN. The demands made on the WAN are significantly reduced by employing multi-hopping techniques, including dynamically avoiding the unnecessary decompression of data at intermediate hops, and exploiting video mosaicing, cut-and-paste and audio mixing technologies so that significantly fewer wide area transmission paths are required while maintaining the high quality of the transmitted audio/video.

U.S. Pat. No. 5,692,213 to Goldberg et al. discloses a method of recording a real-time multimedia presentation and replaying a missed portion at an accelerated rate until the missed portion catches up to the current point in the presentation. The multimedia presentation may consist of audio, video, graphics, and text. A graphical timeline is provided to allow the user easy access to different points in the recorded presentation. All the media formats are synchronized at the accelerated rate and the audio is accelerated without changing its pitch.

U.S. Pat. No. 6,159,016 to Lubell et al. discloses a system and method for producing a personal golf lesson videotape from a visual recording of a person's golf swing and a partially prerecorded instructional golf lesson videotape. The partially prerecorded golf lesson videotape has gaps in predetermined locations into which are inserted the full motion video of the person's golf swing and selected still frames. The system contains two cameras for recording a player's golf swing from the back and side, a computer connected to the cameras for digitally capturing and storing the recorded golf swing, and a computer-controlled video recording device for copying the selected video and still frames of the recorded golf swing into the gaps of the prerecorded videotape golf lesson. The still frames are selected to match the player's position to the position of the professional golfer in corresponding still frames so that a split screen, side-by-side view can be produced showing the player's and professional's positions at various points along a golf swing.

U.S. Pat. No. 6,088,026 to Williams discloses a method and system which permits a user to selectively capture video and audio information from a multimedia presentation within a data processing system and associate the audio and video information to specified calendar events. Thereafter, the video and audio information is played back within the context of electronic calendar events. In addition, associated textual references may be made with the video and audio information to elaborate on the audio and video information associated to the calendar events.

U.S. Pat. No. 6,249,281 B1 to Chen et al. discloses A graphical user interface (“GUI”) comprising: a video region for displaying a video of a presenter giving a presentation; a primary slide region for displaying slides used by the presenter during the presentation; and a thumbnail region containing thumbnails representing slides in the presentation, the thumbnails selectable by a user via a cursor control device.

While the foregoing prior art references demonstrate improvement in the field of multimedia presentations, none of these prior art references disclose a process for creating a multimedia presentation that enables one without specific programming skills to be able to create the synchronized presentation. Nor do they disclose a process that provides high quality output and allows immediate distribution of the recorded presentation.

### SUMMARY OF THE INVENTION

There is, therefore, provided a method for creating a synchronized multimedia presentation. The first step is to provide an encoded video portion of a presentation. This video portion can be prerecorded or recorded in real time. Next, at least one image is extracted from a media portion of the presentation. The extracted image is synchronized to the video portion of the presentation, and the video portion and synchronized extracted images are then outputted to a predetermined source, such as a hard drive or an Internet server.

In one embodiment, the encoded video portion is a previously digitized video portion. In one embodiment, the synchronization occurs in real time. Selected parameters may be edited prior to outputting the video portion and the synchronized extracted image. These editable parameters can include the timing of the synchronized extracted images relative to the encoded video portion, the title of the extracted images, and whether or not to include a particular synchronized extracted image. Moreover, the editable selected parameters can be used to generate a table of contents. Examples of media presentations suitable for use with the present invention include slide presentations and one or more video clips.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a flow chart generally outlining an embodiment of the present invention.

FIG. 2(a) is the Output Destination Screenshot.

FIG. 2(b) is the Server Designation Screenshot.

FIG. 3 is the Choose Background Screenshot.

FIG. 4 is the Final Times-Email-Table of Contents Screenshot

FIG. 5 is the Main Encoding Page Screenshot.

FIG. 6 is the Select Media Presentation Screenshot.

### DETAILED DESCRIPTION OF THE PREFERRED EMBODIMENT(S)

The presently preferred embodiments of the invention will be best understood by reference to the drawings, wherein like parts are designated with like numerals throughout.

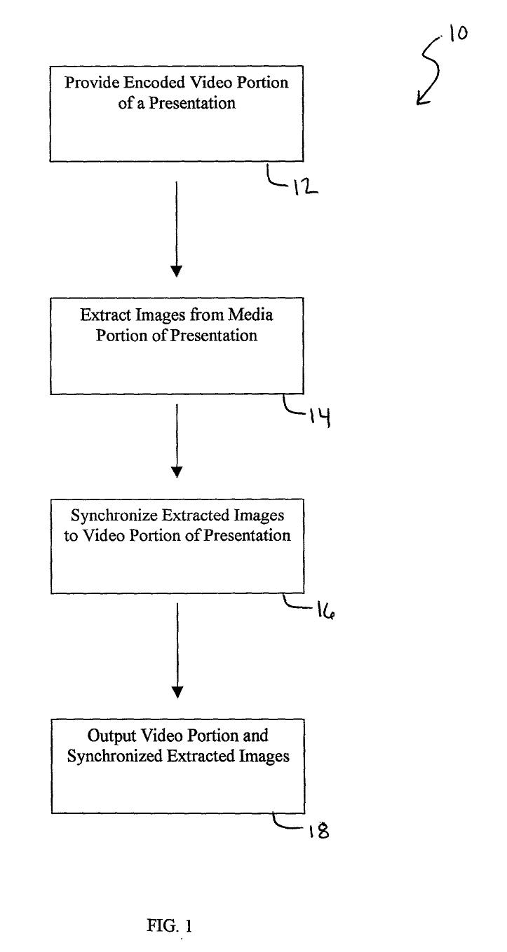

The present invention relates to a system and method for creating and recording synchronized multimedia presentations, and more particularly to a process that allows a non-programmer to create and record a high-quality synchronized multimedia presentation that can be available for immediate distribution. Referring to FIG. 1, a flow chart 10 outlines the process according to the preferred embodiment of the present invention. The first step 12 is to provide an m encoded video portion of a presentation. In one embodiment, the video portion is recorded in real time. For example, if a lecturer is speaking, the lecture can be directly encoded to a PC/encoding machine. Once the video portion has been encoded, the remaining steps of synchronization, extraction and output, as outlined below, are accomplished.

In one embodiment of the present invention, the video portion is a previously digitized video. One advantage to the present invention is that it allows a user to reformat the digitized video in real time. Thus, the user can time stamp, or synchronize, the media presentation to the video as the video is being reformatted.

For example, if a user wishes to generate a presentation based on a prerecorded lecture, the software of the present invention is able to convert a previously digitized video into the necessary format for presentation. Moreover, in the process of converting the previously digitized video, the present invention plays the previously digitized video portion in real time. Since the video portion is playing in real time as it is being reformatted, a user can easily time stamp the images of the media presentation to the video as it plays.

It is noted that, in the absence of the present invention, the process of conversion from one video format to another would occur so rapidly, that it would be virtually impossible to time stamp any slides to the appropriate times in the presentation. The present invention effectively slows the conversion process down to a point that a user would be able to essentially watch the video, as it is reformatted, and make the appropriate time stamps respecting the slides.

The following is the code, from one embodiment, that allows a user to reformat a previously digitized video in real time.

[image]

[image]

[image]

[image]

[image]

[image]

[image]

[image]

[image]

[image]

[image]

[image]

[image]

[image]

[image]

[image]

[image]

It is noted that the foregoing code would allow for conversion of MPG, MOV, RM, AVI and AVIDIVX video formats, among others. However, numerous other video formats currently in use, as well as forthcoming formats, are considered to be within the scope of the present invention.

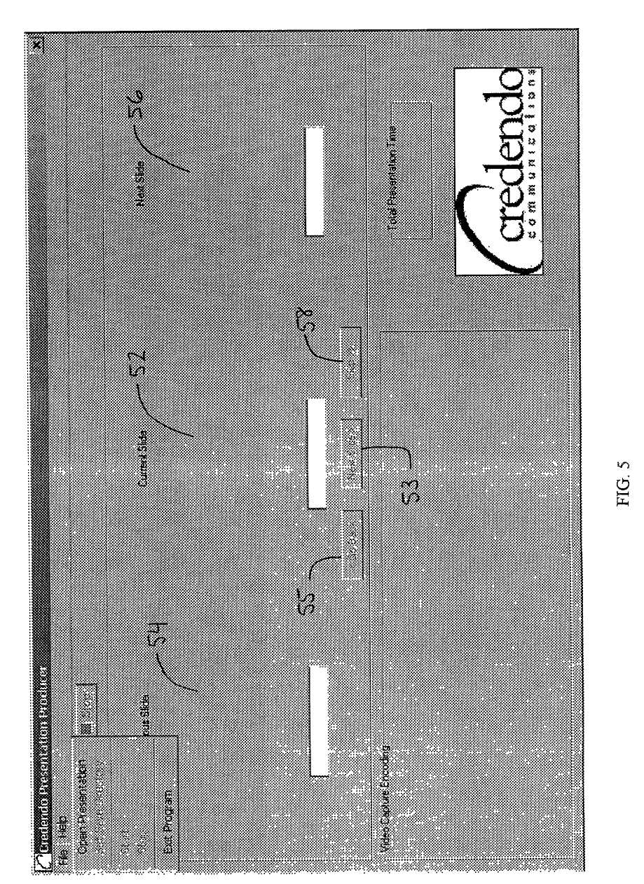

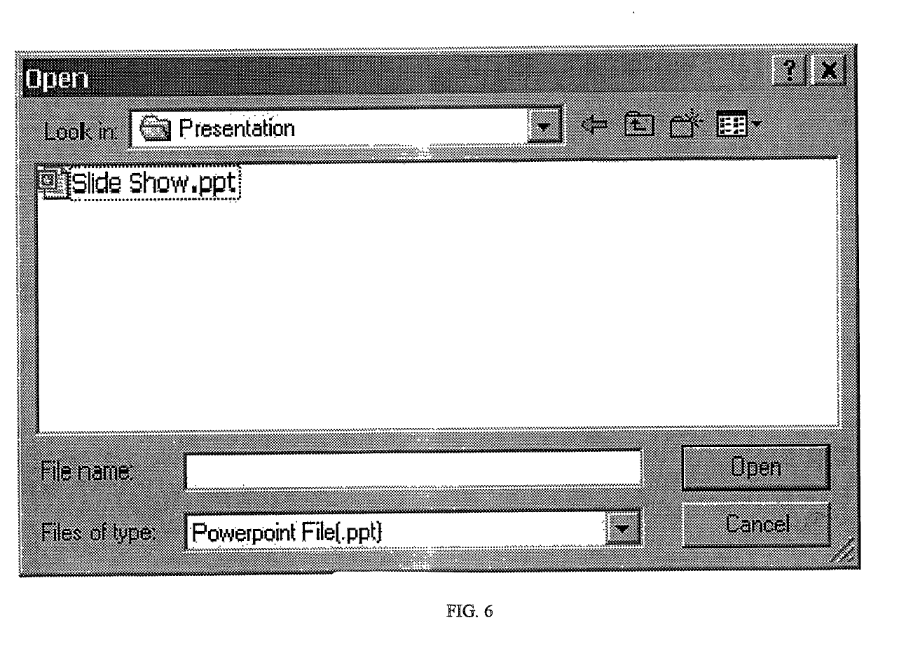

The next step 14, outlined in FIG. 1, is the extraction of at least one image from a media portion of the presentation. If the presentation were being recorded live, the presenter would first select the desired media presentation, such as a slide presentation (see FIG. 6). Extraction software would then extract the images out of the slide presentation. These extracted images could then be projected on an overhead screen, as part of the overall presentation. Or, if such display is not necessary, the images could simply be viewed in a window 52, 54, 56 as shown in FIG. 5.

Outlined below is the code whereby slide images are extracted from PowerPoint® 2000, available from Microsoft, Inc. of Redmond, Wash. However, it is noted that numerous image file formats, including, but not limited to, JPEG, GIF or PNG files could be used. Moreover, the present invention is not limited to use with PowerPoint® or any other proprietary media presentation.

IMAGE EXTRACTION CODE
{

CString tempFileSaveString;
CString tempFileSavePPTString;

//commonly used OLE-variants

COleVariant covTrue ((short)TRUE),

covFalse((short)FALSE),
covOptional((long)DISP_E_PARAMNOTFOUND, VT_ERROR);

PPT::_Application app;
PPT::Presentations presentations;
PPT::_Presentation presentation;
PPT::Slides slides;
PPT::_Slide slide;
PPT::Shapes shapes;
PPT::Shape shape;
PPT::TextFrame textframe;
PPT::TextRange textrange;
if(!app.CreateDispatch(“Powerpoint.Application”))
{

AfxMessageBox(“Could not create Powerpoint object”);
return;

| | |
|---|---|
| } | //if(!app.CreateDispatch(“Powerpoint.Application”); |
| | //make the application visible and minimized |

app.SetVisible((long)TRUE);
app.SetWindowState(long) 2); //WindowMinimized = 2

//Attempt to open a pre-existing ppt

presentations.AttachDispatch(app.GetPresentations( ));
presentation = presentations.Open( m_OpenPPTFile, //strTemplate, //filename

| | |
|---|---|
| (long)0, | //read only |
| (long)-1, | //untitled |
| (long)-1 | //with window |

//get slide names if there are any

slides = presentation.GetSlides( );

//returns total slide count of presentation

m_SlideCount = slides.GetCount( );
CString strSaveLocation;// location of the saved presentation
for (int i = 1; i <= m_SlideCount; i++)
{

CPowerPointSlide tmpSlide;
slides = presentation.GetSlides( );
slide = slides.Item(COleVariant((short)i));
shapes = slide.GetShapes( );
shape = shapes.Item(COleVariant((short)1); //return item 1 textframe
textframe = shape.GetTextFrame( );
try

{

textrange = textframe.GetTextRange( );
tmpSlide.setSlideName(textrange.GetText( ));
UpdateData(FALSE);

}//try
catch(...)
{

tmpSlide.setSlideName(slide.GetName( ));
UpdateData(FALSE);

} //catch(..)
//save location for images
CString slideFileName;
CString tmpString1,tmpString2;
tmpString2.Format(“%i”,i);
slideFileName.Format(“slides\\Slide”); //(“\\TestPPT\\Slide”),
slideFileName = slideFileName + tmpString2;
tmpString1 = m_FileName + slideFileName + “.jpg”; //“png”;
tmpSlide.setImageFileName(tmpString1);

m_PresentSlides.setSlide(tmpSlide);

| }//for (int i = 0; i < m_SlideCount; i++) | |
|---|---|
| //tempFileSaveString = m_TmpDirFileName + “slides”; | |
| tempFileSaveString = m_FileName + “slides”; | |
| presentation.SaveAs(tempFileSaveString,17,TRUE); | //17 will save as JPG and IS is |

PNG 19 is BMP and 16 is Gif

| | |
|---|---|
| presentation.SaveAs(tempFileSaveString,18,TRUE); | //save one as PNG and one as JPEG. |
| tempFileSavePPTString = m_FileName; | //m_TmpDirFileName; |

| m_HTMLFileName.TrimRight(“.ppt”); | |
|---|---|
| _mkdir(m_FileName); | |
| tempFileSavePPTString += m_HTMLFileName; | |
| presentation.SaveAs(tempFileSavePPTString,12,TRUE); | //save an HTML of ppt |

app.Quit( );
m_RunPresentation.EnableWindow(FALSE);
m_Start.EnableWindow(TRUE);

}

In the next step of the process 16, the extracted image is synchronized to the video portion of the presentation. An advantage of the present invention is that the synchronization, or time stamping, of the extracted images to the video portion is done in real time. To illustrate, if the presenter is lecturing live, a video of the lecture is encoded in real time. Under the present invention, the timing of the slides can also be encoded in real time. In other words, by striking a command, such as “Enter” or “Next Slide” 53, the presenter can simultaneously proceed to the next image in the presentation, as well as time stamp the image relative to the video portion. By synchronizing the media and the video portions in this manner, no cumbersome post-presentation production needs to be done. This allows a presenter to have distributable copies of the presentation available soon after the presentation is completed.

If the video portion is previously recorded, synchronization would be accomplished in a similar manner, except that the images would be time stamped at appropriate times while the video was being reformatted.

The time stamping, as well as other data regarding the image (for example, the title of the slide), is temporarily stored in a linked list structure. Moreover, because a preview image 56 is provided, the user can determine whether or not to time stamp a forthcoming slide. Should the user decide to leave out a particular image, he can select the “Skip” command 58. Thus the skipped image will not be time stamped. In a manner similar to PowerPoint®, the user may also “Go Back” 55 to a previous image 54. Again, this image will be time stamped to appear at that point in the presentation. In other words, all controls of forward or back are recorded.

It is noted that in one embodiment, the user has a simultaneous view of the current image 52, the previous image 54, and the next image 56 in the media presentation.

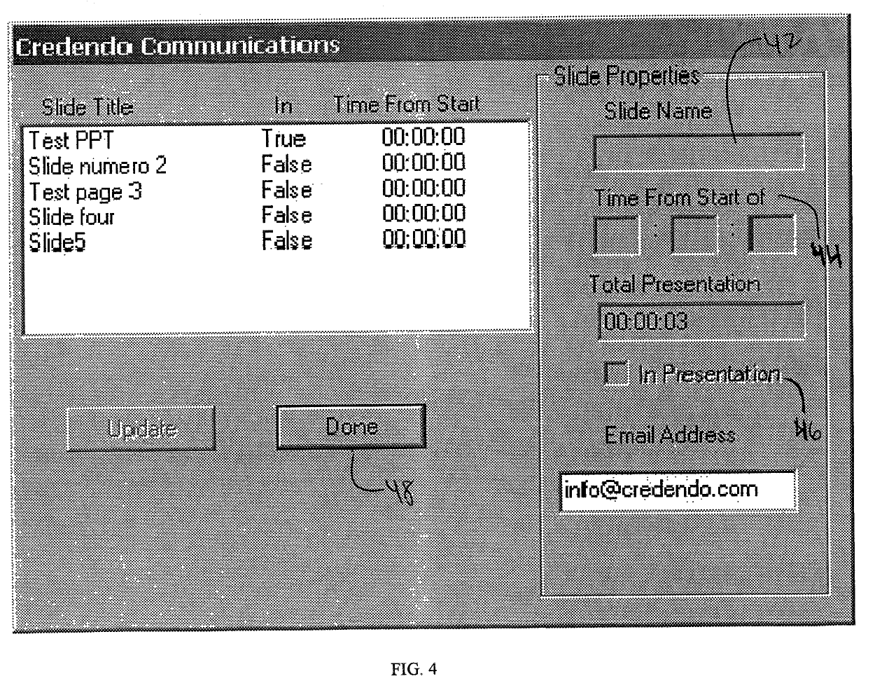

In the present embodiment, HTML code, specifying the timing of the extracted images relative to the encoded video, is written out when the user strikes the “Done” key 48 (FIG. 4). It is noted that while HTML files are generated in this embodiment, other programming languages could also be used.

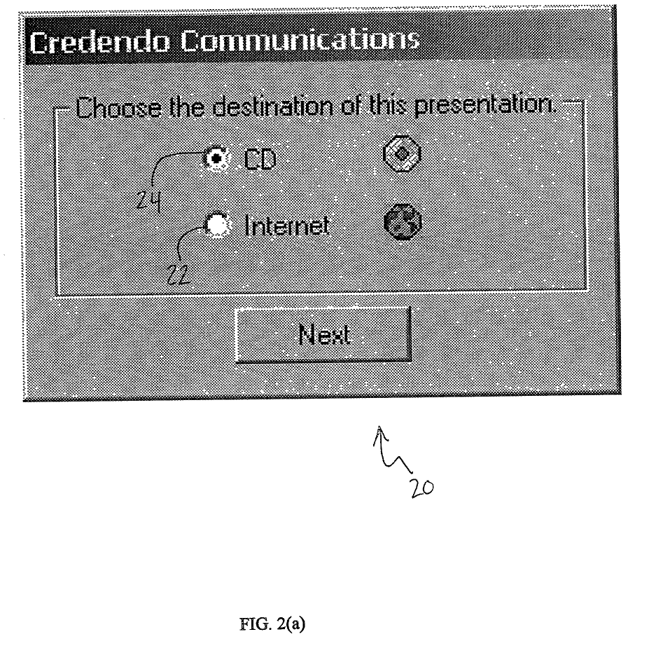

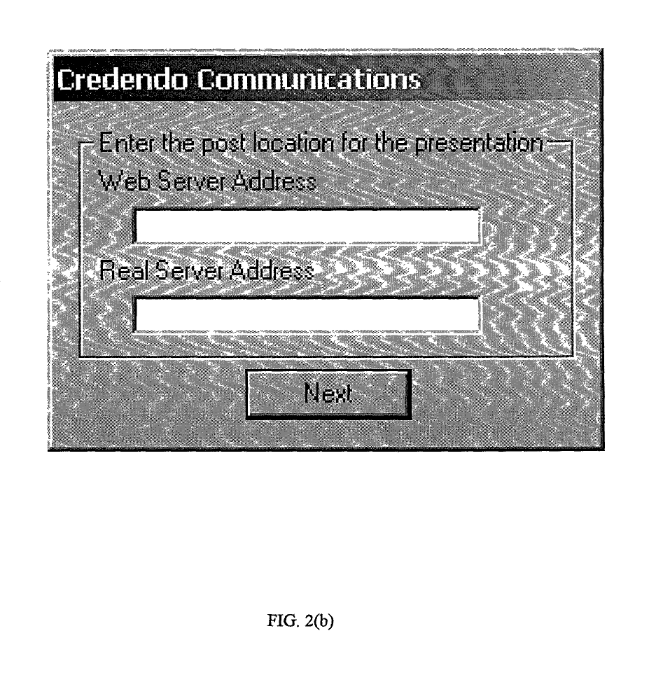

Once the encoded video is synchronized with the extracted images, the images and video are outputted to a designated source. This is the final step 18 of the process outlined in FIG. 1. For example, as seen in FIG. 2(a), the user can specify the presentation be saved to a CD 24, or can direct the presentation be uploaded to an Internet server 22. As would be apparent to one skilled in the art, the output format would need to be different depending on whether the presentation was running off a local file system (as would be the case if the desired output were CDROM), or alternatively streaming from a server (as would be the case if the desired output were the Internet or an intranet).

If the user wishes to upload the presentation for distribution over the Internet, the server address would need to be specified as shown in FIG. 2(b). It is noted that neither selection is necessarily mutually exclusive. In other words, under the present invention, both output versions may be selected simultaneously.

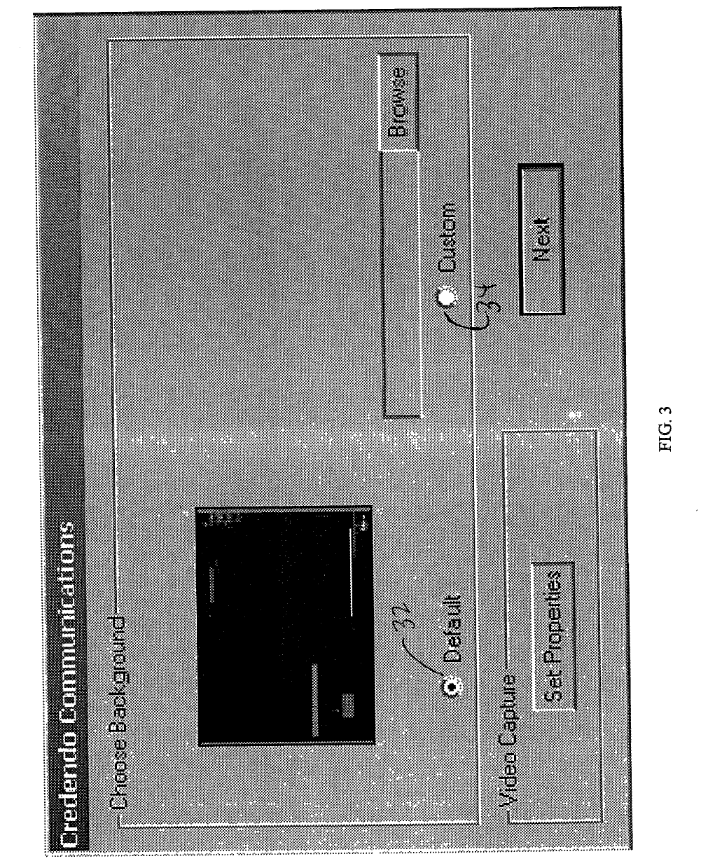

It is noted that under the present invention, the user may select from a variety of layouts for the presentation (i.e. background, sizes and locations of slides, video window, etc.), as shown in FIG. 3. Various preprogrammed layouts 32 can be selected, or alternatively, a user may customize the layout 34.

It is also noted, that while the foregoing specification speaks specifically of encoding video, the same process could be utilized to generate a recorded presentation without the video. For example, if a user wished to distribute a copy of a presentation with only an audio recording of the lecture, along with accompanying slides, the present invention could be used to create such a distributable presentation.

It is also noted that selected parameters may be adjusted or edited prior to finally outputting the presentation. The window enabling such editing is shown in FIG. 4. Specifically, the title of the slides 42, the timing of the slides 44, and whether or not the slides are in a given presentation 46, can all be adjusted and edited prior to finally outputting the presentation. Moreover, media images could also be imported that were not otherwise in the presentation. For example, if a presenter, after having completed the presentation, came across an image that he desired to include in the presentation, the image could be saved as an appropriate file type, then added to the presentation. These added images can also later be edited with respect to time, title and presence. Additionally, the data within these selected parameters can be used to generate a table of contents.

As noted above, a significant advantage of the present system is that it allows a presenter without programming skills to quickly generate a distributable copy of a presentation. A further advantage of the present process and system is that allows a presenter to produce the recorded presentation himself. In other words, the present invention can be configured such that when the presenter strikes the command “Enter” or “Next Slide” to change the slide (or other media image), this command synchronizes that particular slide to that specific time on the video. This allows the synchronization to be done in real time, by the presenter, as the presentation is taking place.

Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, form, function, manner of operation and use may be made without departing from the principles and concepts set forth herein.

What is claimed is:

1. A method for creating a synchronized multimedia presentation, comprising the steps of:
a) providing an encoded video portion of a presentation;
b) extracting at least one image from a media portion of the presentation;
c) synchronizing the extracted image to the video portion of the presentation; and
d) outputting the video portion and the synchronized extracted image to a predetermined source.

2. The method of claim 1, wherein the encoded video portion is a previously digitized video portion.

3. The method of claim 1, wherein the synchronization occurs in real time.

4. The method of claim 1, further comprising the step of editing selected parameters prior to outputting the video portion and the synchronized extracted image to a predetermined source.

5. The method of claim 4, wherein the selected parameter is timing of the synchronized extracted image relative to the encoded video portion.

6. The method of claim 4, wherein the selected parameter is title of the extracted image.

7. The method of claim 4, wherein the selected parameter defines whether or not to include a particular synchronized extracted image.

8. The method of claim 1, wherein the predetermined source is selected from the group consisting of: a hard drive and an Internet server.

9. The method of claim 1, wherein the encoded video portion of a presentation is a prerecorded presentation.

10. The method of claim 11, wherein the encoded video portion of a presentation is recorded in real time.

11. The method of claim 1, wherein the media presentation is a slide presentation.

12. The method of claim 1, wherein the media presentation is at least one video clip.

13. The method of claim 4, wherein the selected parameters are used to generate a table of contents.
